(19) United States
(12) Patent Application Publication
(10) Pub. No.: US 2023/0327507 A1
(43) Pub. Date: Oct. 12, 2023

(54) STATOR WITH BENDING REGION GROUPS, ELECTRIC MACHINE AND MOTOR VEHICLE

(71) Applicant: VOLKSWAGEN AKTIENGESELLSCHAFT, Wolfsburg (DE)

(72) Inventors: Arash SHAGHAGHI, Lohfelden (DE); Thomas PASTERNOK, Kassel (DE)

(73) Assignee: VOLKSWAGEN AKTIENGESELLSCHAFT, Wolfsburg (DE)

(21) Appl. No.: 18/128,861

(22) Filed: Mar. 30, 2023

(30) Foreign Application Priority Data
Apr. 12, 2022 (DE) 10 2022 203 673.5

(51) Int. Cl. H02K 3/14; H02K 3/48; H02K 3/28; H02K 9/19

(52) U.S. Cl. CPC H02K 3/14; H02K 9/19; H02K 3/28; H02K 3/48

(57) ABSTRACT

A stator for an electric machine comprises a stator base body and a plurality of winding rods, each having a bending region from which two axial wire arms extend with an arm end pointing away from the bending region, the wire arms being arranged in the stator slots of the stator one above another in the radial direction. The winding bars are each assigned to one of a plurality of phases of the stator. The bending regions on a first base body end face of the stator base body form a first end winding. The arm ends on a second base body end face of the stator base body form a second end winding and are electrically coupled to one another in pairs in each case. Adjacent bending regions are combined to form bending region groups and are arranged predominantly in alignment one behind the other in the radial direction.

### CROSS REFERENCE TO RELATED APPLICATION

This application claims priority from German Patent Application No. 10 2022 203 673.5, filed on Apr. 12, 2022, which is hereby incorporated by reference in its entirety.

### FIELD OF THE INVENTION

The present invention relates to a stator for an electric machine for driving a motor vehicle. The invention further relates to an electric machine having a stator of the type in question, and to a motor vehicle having an electric machine of the type in question.

### BACKGROUND OF THE INVENTION

Electrical and hybrid drive systems for motor vehicles are known, which have an electric machine for driving the motor vehicle. In order to achieve high power densities, electric machines are known in which stator windings are formed of winding bars which are arranged in stator slots of a stator base body of the stator. Such winding bars are sometimes also referred to as “hairpins”, as they have a hairpin-like design.

The winding bars accordingly each have a U-shaped bending region, from which two wire arms each extend with a free arm end. In order to implement the stator winding, two adjacent arm ends of different winding bars are electrically coupled to one another, for example welded, crimped, soldered or the like. Thus, the bending regions on a first base body end face form a first end winding, and the arm ends on a second base body end face opposite the first base body end face form a second end winding.

In the case of electric machines having a relatively high power density and a relatively high continuous power density, thermal management is of particular importance for avoiding overheating of the components of the electric machine. A plurality of different cooling concepts, such as general air cooling and liquid cooling of the rotor and/or the stator using a cooling liquid, is known in this context.

Stator coolers for cooling the stator are known, in which the stator base body has cooling channels for the passage of the cooling liquid. In this way, reliable and effective cooling of the stator base body can be achieved. Nevertheless, no direct cooling of the end windings is achieved in this way, such that overheating of the end windings can easily occur, in particular when the electric machine is subjected to a high continuous power load. For this reason, some electric machines have additional end winding cooling. This can be achieved for example indirectly by arranging what are known as “heat pipes” or heat dissipation elements in the end winding. Another possibility for active cooling of the end winding is the direct application of cooling liquid to the end winding.

A known direct end winding cooling is also known under the designation “spray cooling” or “centrifugal cooling”. According to one embodiment, a cooling liquid channel having a cooling liquid centrifugation region is formed on the rotor. As a result of the centrifugal forces occurring during a rotation of the rotor, the cooling liquid can be spun from the cooling liquid centrifugation region of the rotor to each of the adjacent end windings. Such centrifugal cooling devices are known from US 2020/0 328 657 A1, DE 10 2014 207 470 A1, and DE 10 2013 020 331 A1.

Known centrifugal cooling devices have the disadvantage that a penetration depth of the cooling liquid, which is spun radially outward toward the end windings and into the end windings is limited by the winding bars, since the cooling liquid directly hits the winding bars arranged further inward in the radial direction and loses its kinetic energy at said winding bars. As a result, an application of the cooling liquid to the winding bars arranged further outward in the radial direction is ensured only insufficiently. One reason for this is the arrangement of the bending regions in the end winding, which has a plurality of wire crossings of adjacent winding bars and thus forms a barrier for the cooling liquid.

### SUMMARY OF THE INVENTION

It is, therefore, the object of the present invention to eliminate or at least in part eliminate the disadvantages described above in an electric machine. In particular, the object of the present invention is to provide a stator, an electric machine, and a motor vehicle having an electric machine, which prevent insufficient application of cooling liquid to at least one end winding and/or provide improved cooling of at least one end winding in a simple and cost-effective manner.

The above object is achieved by the claims. According thereto, the object is achieved by a stator for an electric machine for driving a motor vehicle having the features claimed, by an electric machine having the features claimed, and by a motor vehicle having the features claimed. Further features and details of the invention follow from the dependent claims, the description and the drawings. In this case, features and details that are described in connection with the stator according to the invention naturally also apply in connection with the electric machine according to the invention and to the motor vehicle according to the invention, and vice versa in each case, such that reference is or can always be made, reciprocally, to the disclosure of the individual aspects of the invention.

According to a first aspect of the invention, the object is achieved by a stator for an electric machine for driving a motor vehicle. The stator comprises a stator base body having a first base body end face, a second base body end face, a base body longitudinal axis, stator teeth, and stator slots formed between the stator teeth. In addition, the stator has a plurality of winding bars each having a bending region, from which two axial wire arms of the winding bar extend, each with an arm end pointing away from the bending region. The wire arms of the winding bars are arranged one above the other in the stator slots in the radial direction, the winding bars each being assigned to one of a plurality of phases of the stator. The bending regions form a first end winding on the first base body end face. The arm ends form a second end winding on the second base body end face, the arm ends on the second base body end being electrically coupled to one another in pairs in each case. According to the invention, adjacent bending regions are combined to form bending region groups and are arranged predominantly in alignment one behind the other in the radial direction.

The stator base body consists, for example, of iron or comprises at least iron and/or a ferromagnetic material. Preferably, the stator base body is composed of a plurality of stator disks, preferably electrical sheets or the like. The stator disks are preferably electrically insulated from one another by means of an insulating means. The insulating means preferably comprises resin, lacquer, paper or the like. The stator base body is formed coaxially with the base body longitudinal axis. The stator base body has a plurality of stator slots which are preferably open toward the base body longitudinal axis, and which further preferably extend in parallel with the base body longitudinal axis through the stator base body. The stator slots have a slot depth in the radial direction. Furthermore, the stator slots are delimited by the stator teeth in the circumferential direction of the stator base body. It is preferred according to the invention that the stator slots are distributed uniformly or at least regularly over the stator base body. It is preferred that electrical slot insulating material, which can be introduced into the stator slots in particular as a casting compound, is arranged in the stator slots. The slot insulating material is preferably arranged on a slot wall of the stator slot. The stator base body is delimited in the axial direction by the first base body end face and the second base body end face.

The winding bars are designed as hairpins and have a bending region from which two wire arms extend, preferably in parallel or at least substantially in parallel. The wire arms each extend with an arm end on a side facing away from the bending region. The winding bars are thus U-shaped or at least substantially U-shaped. The winding bars are further preferably formed of a material having a high electrical conductivity, such as copper or the like. Further preferably, the winding bars are electrically insulated around their circumference in order to prevent a short circuit between adjacent winding bars. The winding bars preferably have a rectangular bar cross section. Preferably, the winding bars have a bar width which corresponds to or is slightly smaller than a slot width of the stator slots, such that a movement of the winding bars in the circumferential direction is positively limited by the stator teeth. The winding bars preferably have a bar height which is less than the bar width. A ratio of bar height to bar width is preferably between 1:2 and 4:5, preferably about 2:3. Accordingly, the winding bars preferably have a rectangular cross section with different edge lengths.

The wire arms of the winding bars are arranged one above the other in the stator slots in the radial direction, such that the same number of wire arms is preferably arranged in each stator slot, for example 6 or 8 wire arms per stator slot. The bending regions of the winding bars are guided out of the stator slots on the first base body end face, and form the first end winding. The arm ends of the winding bars are guided out of the stator slots on the second base body end face, and form the second end winding. In order to produce a multiphase stator winding, the arm ends are electrically coupled to one another in a specific manner in pairs, for example by welding, soldering, crimping or the like. The stator winding preferably has a plurality of phases, in particular three phases.

According to the invention, the bending regions of the first end winding are combined to form bending region groups. A bending region group is characterized in that adjacent bending regions of a bending region group are at a smaller distance from one another than from bending regions of adjacent bending region groups. Preferably, the bending regions of a bending region group are arranged such that adjacent bending regions of the bending region group contact one another along their common longitudinal extension, and preferably contact each other at least over a distance which is greater than a width of the wire arms. Thus, free spaces extending in the radial direction are formed between adjacent bending region groups, into which free spaces a cooling liquid which is centrifuged away from the rotor can penetrate easily. The bending region groups are preferably designed such that said free spaces provide the largest possible contact surface for the coolant inside the first end winding. The contact surface preferably has a radial and an axial extension component, and also an extension component in the circumferential direction, such that a particularly large inflow surface for the cooling liquid is provided, which surface extends far into the first end winding. Preferably, the contact surface is formed in the shape of a paddle wheel. This means that the contact surface is preferably twisted about an axis, preferably about an axis extending in parallel with the base body longitudinal axis.

A stator according to the invention has the advantage over conventional stators that penetration of the first end winding for the cooling liquid which is centrifuged away from the rotor is improved by simple means and in a cost-effective manner. As a result, the cooling liquid can also be applied to winding bars of the first end winding which are arranged radially further away from the longitudinal axis of the base body, such that improved cooling of the first end winding is ensured.

According to a preferred development of the invention, it can be provided, in the case of a stator, that the bending region groups have three or four bending regions. In other words, it is preferred that the bending regions of three or four winding bars are combined to form a bending region group. In the case of six wire arms per stator slot, there are preferably three bending regions per bending region group. In the case of eight wire arms per stator slot, there are preferably four bending regions per bending region group. It is preferred, according to the invention, that the number of bending regions per bending region group corresponds to half or one third of the number of wire arms per stator slot. This has the advantage that bending region groups are provided, by simple means and in a cost-effective manner, which ensure improved penetration of the first end winding for the cooling liquid centrifuged away from the rotor, such that improved cooling of the first end winding is ensured.

It is preferred, according to the invention, that a gap extending along the respective bending regions and in the radial direction is formed between adjacent bending region groups. The gap preferably extends along the entire bending region group up to the adjacent bending region groups arranged radially further outward. It is thus ensured that cooling liquid which is centrifuged away from the rotor can move past the inner bending region groups and reach the bending region groups arranged radially further outward. This has the advantage that cooling of the first end winding is improved using simple means and in a cost-effective manner.

Further preferably, the winding bars of one bending region group are arranged in the same stator slots. Therefore, in the case of 48 stator slots, for example two winding bars of a bending region group can each have a wire arm arranged in a first stator slot and a wire arm arranged in a seventh stator slot. The arrangement in the same stator slots ensures an aligned or substantially aligned arrangement of the bending regions, such that cooling liquid which is centrifuged away from the rotor can more easily move past the inner bending region groups and reach the bending region groups arranged radially further outward. This has the advantage that cooling of the first end winding is further improved using simple means and in a cost-effective manner.

In a particularly preferred embodiment of the invention, it can be provided, in the case of a stator, that the bending regions of a bending region group have a twisting that has a common twisting direction. The twisting is preferably formed about a longitudinal axis of the winding bars. A twisting angle is preferably between 5° and 90°, particularly preferably between 10° and 60°, and more preferably between 15° and 45°. Particularly preferably, the twisting is arranged in portions of the bending regions which are arranged adjacent to the first base body end face, portions of the bending regions which are further away from the first base body end face preferably having no or less twisting. In this way, it is possible to ensure that cooling liquid which is centrifuged away from the rotor can more easily move past the inner bending region groups and reach the bending region groups arranged radially further outward. This has the advantage that cooling of the first end winding is further improved using simple means and in a cost-effective manner.

Preferably, the winding bars extend toward the bending regions along a first distance in parallel with the base body longitudinal axis as they exit the stator slots. In the context of the invention, a parallel extension is also understood to mean a deviation of +1-10° from a purely parallel extension. The first distance is preferably at least 20% of an extension of the first end winding from the first base body end face. Further preferably, the first distance is at least 40%, particularly preferably at least 50%, of the extension of the first end winding from the first base body end face. In this case, it is preferred that the bending regions lying further inward in the radial direction have a greater extension of this kind than the bending regions lying further outward in the radial direction, for example, bending regions of different bending region groups. Thus, application to the bending region groups lying further outward in the radial direction can be further improved. This has the advantage that cooling of the first end winding is further improved using simple means and in a cost-effective manner.

According to a preferred embodiment of the invention, the first distance is between 5 mm and 30 mm. Particularly preferably, the first distance is approximately 20 mm. Thus, application to the bending region groups lying further outward in the radial direction can be further improved. This has the advantage that cooling of the first end winding is further improved using simple means and in a cost-effective manner.

Particularly preferably, the arm ends have an offset, the winding bars being formed in a region between an axial end of the second end winding and the offset, in parallel with the base body longitudinal axis. Preferably, the winding bars extend toward the bending regions along a first distance in parallel with the base body longitudinal axis as they exit the stator slots. A spacing of the offset from the second base body end face is preferably between 5 mm and 20 mm. Preferably, a second distance between the axial end of the second end winding and the offset is greater in the case of winding wires lying further inward in the radial direction than in the case of winding wires lying further outward in the radial direction. Alternatively or additionally, it is preferred that the offset is designed such that a gap extending outward in the radial direction between the arm ends has an extension component in the circumferential direction. In this way, a surface area of the arm ends to which the cooling liquid can be applied is enlarged. This has the advantage that cooling of the first end winding is further improved using simple means and in a cost-effective manner.

According to a second aspect of the invention, the object is achieved by an electric machine for a motor vehicle. The electric machine comprises a rotor having a rotor longitudinal axis, a cooling liquid channel for conducting a cooling liquid, and a cooling liquid centrifugation region for centrifuging away the cooling liquid in a radial direction during rotation of the rotor. According to the invention, the electric machine has a stator according to the invention. The cooling liquid centrifugation region is preferably designed to apply cooling liquid to the end windings in a uniform manner. Alternatively, the cooling liquid centrifugation region can be designed in accordance with the invention to apply the first end winding differently, in such a way that the cooling liquid is applied more strongly to bending regions lying further outward in the radial direction than would be the case with a uniform distribution of the application of cooling liquid.

All the advantages that have already been described for a stator according to the first aspect of the invention arise for the electric machine according to the invention. Accordingly, in comparison with conventional electric machines, the electric machine according to the invention has the advantage that penetration of the first end winding of the stator of the electric machine, for the cooling liquid which is centrifuged away from the rotor, is improved. As a result, the cooling liquid can also be applied to winding bars of the first end winding which are arranged radially further away from the longitudinal axis of the base body, such that improved cooling of the first end winding is ensured.

According to a third aspect of the invention, the object is achieved by a motor vehicle. The motor vehicle has an electrical drive system or a hybrid drive system. According to the invention, the drive system comprises an electric machine according to the invention. In the case of a hybrid drive system, the electric machine is preferably designed for supporting driving of the motor vehicle. Alternatively or additionally, the electric machine can be designed, in a hybrid drive system, for driving the motor vehicle by itself. In the case of an electrical drive system, the electric machine is designed to drive the motor vehicle by itself. According to the invention, the electrical drive system or the hybrid drive system can also comprise a plurality of electric machines.

In the motor vehicle according to the invention, all advantages arise which have already been described with respect to a stator according to the first aspect of the invention and to an electric machine according to the second aspect of the invention. Accordingly, compared to conventional motor vehicles, the motor vehicle according to the invention has the advantage of improved penetration of the first end winding of the stator of the electric machine of the drive system for the cooling liquid which is centrifuged away from the rotor. As a result, the cooling liquid can also be applied to winding bars of the first end winding which are arranged radially further away from the longitudinal axis of the base body, such that improved cooling of the first end winding is ensured.

### BRIEF DESCRIPTION OF THE DRAWINGS

A stator according to the invention, an electric machine according to the invention, and a motor vehicle according to the invention are explained in more detail below with reference to drawings. In the drawings, in each case schematically:

FIG. 1 is a perspective view of a detail of a first end winding of a stator according to the prior art,

FIG. 2 is a sectional view of an electric machine according to a preferred embodiment of the invention,

FIG. 3 is a side view of a bending region group according to a preferred first embodiment of the invention,

FIG. 4 is a perspective view of a detail of a first end winding according to the preferred first embodiment of the invention,

FIG. 5 is a side view of a bending region group according to a preferred second embodiment of the invention,

FIG. 6 is a perspective view of a detail of a first end winding according to the preferred second embodiment of the invention,

FIG. 7 shows a winding pattern according to the preferred second embodiment of the invention,

FIG. 8 is a perspective view of a detail of a second end winding according to the preferred embodiment of the invention, and

FIG. 9 is a side view of a preferred embodiment of a motor vehicle according to the invention.

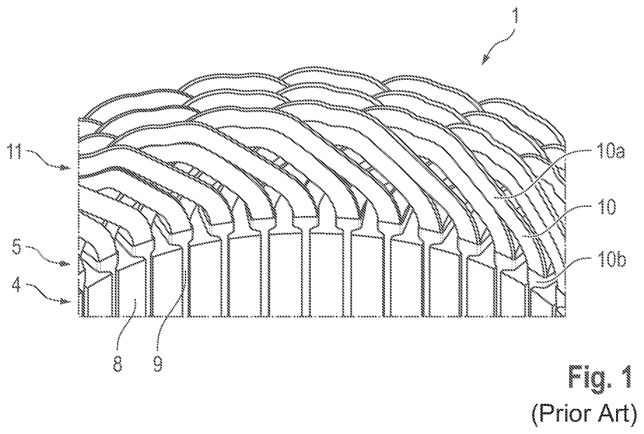

Elements having the same function and mode of operation are each provided with the same reference signs in FIGS. 1 to 9.

### DETAILED DESCRIPTION OF THE INVENTION

FIG. 1 is a schematic perspective view of a detail of a first end winding 11 of a stator 1 according to the prior art. The stator 1 comprises a stator base body 4 having a plurality of stator teeth 8. A stator slot 9 is formed between each pair of two stator teeth 8. Wire arms 10b of a plurality of winding bars 10 are arranged in the stator slots 9. The first end winding 11 is arranged on a first base body end face 5 of the stator base body 4 and is formed from a plurality of bending regions 10a of the winding bars 10. Due to the uniform distribution of the bending regions 10a, the first end winding 11 has a plurality of crossings between adjacent bending regions 10a, which greatly hinder the penetration of the first end winding 11 by centrifuged oil.

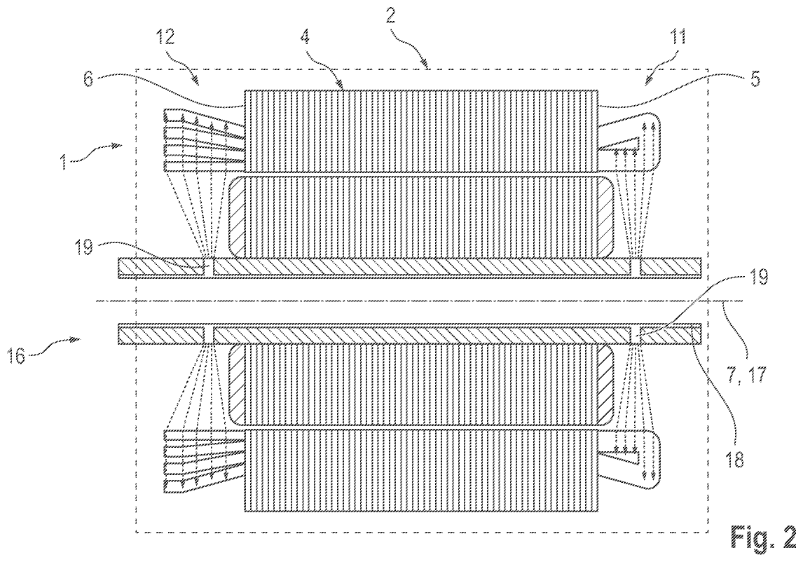

FIG. 2 is a schematic sectional view of an electric machine 2 according to a preferred embodiment of the invention. The electric machine 2 comprises a stator 1 according to the invention, having a stator base body 4 which extends along a base body longitudinal axis 7 and which has a first base body end face 5 and a second base body end face 6. A first end winding 11 is arranged on the first base body end face 5 and a second end winding 12 is arranged on the second base body face 6. Furthermore, the electric machine 2 comprises a rotor 16 having a rotor longitudinal axis 17 arranged coaxially with the base body longitudinal axis 7. A cooling liquid channel 18 for conducting a cooling liquid is formed in the rotor 16. The cooling liquid channel 18 opens into a plurality of cooling liquid centrifugation regions 19, via which the cooling liquid can be centrifuged, by rotation of the rotor 16, onto the first end winding 11 and the second end winding 12. Due to the design of the stator 1 according to the invention, improved penetration of the first end winding 11 and of the second end winding 12 with the cooling liquid can be achieved.

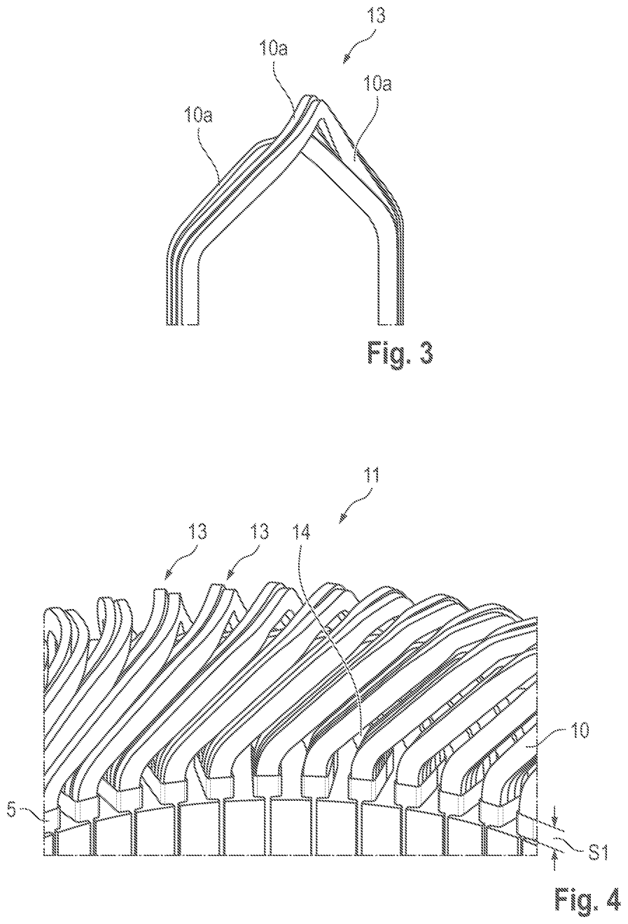

FIG. 3 is a schematic side view of a bending region group 13 according to a preferred first embodiment of the invention. The bending region group 13 is formed of three bending regions 10a. The bending region group 13 is thus formed of three winding bars 10 designed as hairpins.

FIG. 4 is a schematic perspective view of a detail of a first end winding 11 according to the preferred first embodiment of the invention. The first end winding 11 has a plurality of the bending region groups 13 shown in FIG. 3. A gap 14 for improved passage of the cooling liquid is formed between two adjacent bending region groups 13. The winding bars 10 extend from the first base body end face 5 over a first distance S1 in parallel with the base body longitudinal axis 7 (see FIG. 2).

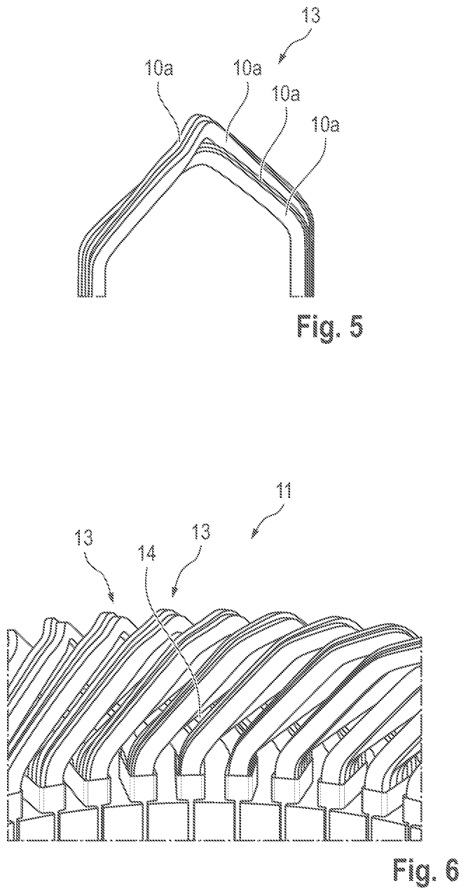

FIG. 5 is a schematic side view of a bending region group 13 according to a preferred second embodiment of the invention. The bending region group 13 is formed of four bending regions 10a. The bending region group 13 is thus formed of four winding bars 10 designed as hairpins.

FIG. 6 is a schematic perspective view of a detail of a first end winding 11 according to the preferred second embodiment of the invention. The first end winding 11 has a plurality of the bending region groups 13 shown in FIG. 5. A gap 14 for improved passage of the cooling liquid is formed between two adjacent bending region groups 13.

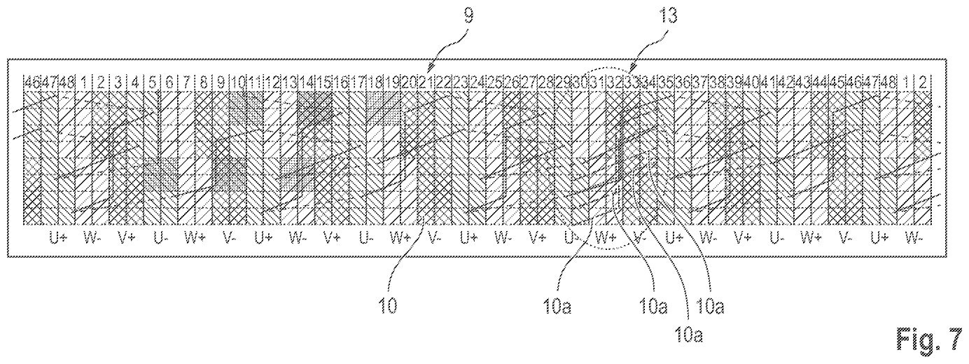

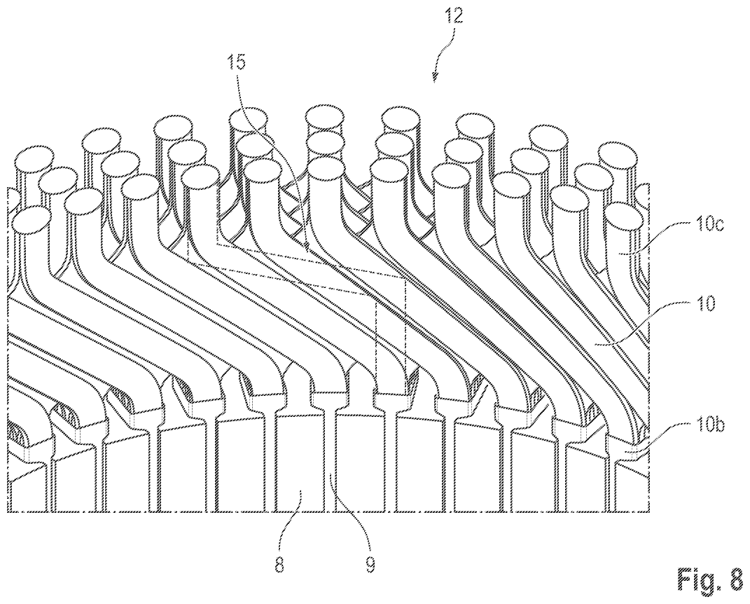

FIG. 7 schematically shows a winding pattern according to the preferred second embodiment of the invention. The winding pattern shows forty-eight stator slots 9, in each of which eight winding bars 10 are arranged. Each of the stator slots 9 thus has eight slot positions, a top slot position in this illustration being referred to as the first slot position, and the slot positions arranged below being numbered as far as the bottommost eighth slot position. Each winding phase has four parallel coils each having a winding start 11 and a winding end 12. The winding bars 10 are arranged with the same pitch into bending region groups 13, each having four bending regions 10a. A bending region group 13 according to the preferred second embodiment of the invention shown in FIG. 5 is highlighted by way of example in the center of the winding pattern. The winding bars 10 are arranged in stator slots 9 twenty-one and twenty-six. A first pair of winding bars 10 is arranged in stator slot 9 twenty-one, in slot position eight, and in stator slot 9 twenty-six, in slot position two. A second pair of winding bars 10 is arranged in stator slot 9 twenty-one, in slot position seven, and in stator slot 9 twenty-six, in slot position one. A third pair of winding bars 10 is arranged in stator slot 9 twenty-one, in slot position six, and in stator slot 9 twenty-six, in slot position four. A fourth pair of winding bars 10 is arranged in stator slot 9 twenty-one, in slot position five, and in stator slot 9 twenty-six, in slot position three.

FIG. 8 is a schematic, perspective view of a detail of a second end winding 12 according to the preferred embodiment of the invention. The second end winding 12 is arranged on the second base body end face 6 and is formed of a plurality of arm ends 10c of the winding bars 10, which are in each case electrically coupled to one another in pairs, for example by welding or the like. An arm end 10c according to an alternative embodiment is indicated by a dashed line. In this alternative embodiment, the winding bar 10 protruding from the stator slot 9 initially extends in parallel with the base body longitudinal axis 7 (see FIG. 2) up to an offset 15. This provides a particularly advantageous permeability of the second end winding 12 for cooling liquid between the second base body end face 6 and the offset 15.

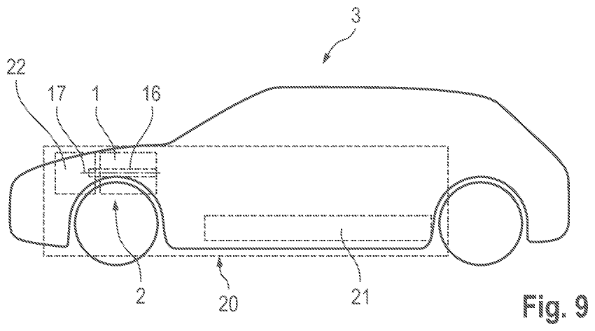

FIG. 9 is a schematic side view of a preferred embodiment of a motor vehicle 3 according to the invention. The motor vehicle 3 comprises an electrical drive system 20 having an electric machine 2 according to the invention for driving the motor vehicle 3, a traction battery 21 for providing electrical energy for operating the electric machine 2, and a transmission 22 for the targeted conversion of an output speed of the electric machine 2. The electric machine 2 comprises a rotor 16 having a rotor longitudinal axis 17, and a stator 1 according to the invention.

### LIST OF REFERENCE SIGNS

1 stator
2 electric machine
3 motor vehicle
4 stator base body
5 first base body end face
6 second base body end face
7 base body longitudinal axis
8 stator tooth
9 stator slot
10 winding bar
10a bending region
10b wire arm
10c arm end
11 first end winding
12 second end winding
13 bending region group
14 gap
15 offset
16 rotor
17 rotor longitudinal axis
18 cooling liquid channel
19 cooling liquid centrifugation region
20 drive system
21 traction battery
22 transmission
S1 first distance

1. A stator for an electric machine for driving a motor vehicle, comprising:
a stator base body having a first base body end face, a second base body end face, a base body longitudinal axis, stator teeth, and stator slots formed between the stator teeth,
a plurality of winding rods, each having a bending region from which two axial wire arms of the respective winding rod each extend with an arm end pointing away from the bending region,
wherein the wire arms of the winding bars are arranged in the stator slots one above the other in the radial direction,
wherein each of the winding bars is assigned to one of a plurality of phases of the stator,
wherein the bending regions on the first base body end face form a first end winding, and
wherein the arm ends on the second base body end face form a second end winding, the arm ends on the second base body end face are electrically coupled to one another in pairs in each case,
wherein adjacent bending regions are combined to form bending region groups and are arranged predominantly in alignment one behind the other in the radial direction.

2. The stator according to claim 1, wherein the bending region groups have three or four bending regions.

3. The stator according to claim 1, wherein a gap extends along the respective bending regions and in the radial direction, said gap being formed between adjacent bending region groups.

4. The stator according to claim 1, wherein the winding bars of a bending region group are arranged in the same stator slots.

5. The stator according to claim 1, wherein the bending regions of a bending region group have a twisting that has a common twisting direction.

6. The stator according to claim 1, wherein the winding bars extend toward the bending regions along a first distance in parallel with the base body longitudinal axis as the winding bars exit the stator slots.

7. The stator according to claim 6, wherein the first distance is between 5 mm and 20 mm.

8. The stator according to claim 1, wherein the arm ends have an offset, the winding bars being formed in parallel with the base body longitudinal axis in a region between the second base body end face and the offset.

9. An electric machine for a motor vehicle, comprising:
a rotor having a rotor longitudinal axis,
a cooling liquid channel for conducting a cooling liquid,
a cooling liquid centrifugation region for centrifuging away the cooling liquid in a radial direction during rotation of the rotor, and
a stator according to claim 1.

10. A motor vehicle comprising an electrical or hybrid drive system, wherein the drive system comprises an electric machine according to claim 9.
